(19) United States
(12) Patent Application Publication
(10) Pub. No.: US 2014/0340310 A1
(43) Pub. Date: Nov. 20, 2014

(54) INPUT DEVICE AND FUNCTION SWITCHING METHOD THEREOF

(71) Applicant: Wistron Corporation, New Taipei City (TW)

(72) Inventors: Kai-Chung Cheng, New Taipei City (TW); Sheng-Hsien Hsieh, New Taipei City (TW); Shou-Te Wei, New Taipei City (TW)

(21) Appl. No.: 13/924,634

(22) Filed: Jun. 24, 2013

(30) Foreign Application Priority Data
May 17, 2013 (TW) 102117643

(51) Int. Cl. G06F 3/023

(52) U.S. Cl. CPC G06F 3/023
USPC 345/158

(57) ABSTRACT

An input device includes a housing; a plurality of keyswitches disposed on the housing; a touch panel disposed on the housing; and a processing unit disposed in the housing and electrically connected to the keyswitches and the touch panel, the processing unit being used for switching coordinate information outputted by the touch panel to a cursor control function or a virtual numeric keypad function.

### BACKGROUND OF THE INVENTION

1. Field of the Invention

The invention relates to an input device and a function switching method thereof and, more particularly, to an input device and a function switching method thereof capable of switching coordinate information outputted by a touch panel to a cursor control function or a virtual numeric keypad function.

2. Description of the Prior Art

Referring to FIG. 1, FIG. 1 is a schematic diagram illustrating a notebook computer 1 of the prior art. As shown in FIG. 1, a keyboard 10 of the conventional notebook computer 1 only provides a row of numeric keys on the upside due to space consideration. If a user needs to input a larger number of numerals (e.g. to keep account or trial balance), the row of numeric keys on the upside is inconvenient for operation. Therefore, the user has to purchase an additional numeric keypad and connects the numeric keypad to the notebook computer 1 externally, so as to input a larger number of numerals. The numeric keypad not only increases additional expense but also is inconvenient in use and transportation.

### SUMMARY OF THE INVENTION

The invention provides an input device and a function switching method thereof capable of switching coordinate information outputted by a touch panel to a cursor control function or a virtual numeric keypad function, so as to solve the aforesaid problems.

According to the claimed invention, an input device includes a housing; a plurality of keyswitches disposed on the housing; a touch panel disposed on the housing; and a processing unit disposed in the housing and electrically connected to the keyswitches and the touch panel, the processing unit being used for switching coordinate information outputted by the touch panel to a cursor control function or a virtual numeric keypad function.

According to the claimed invention, when the coordinate information outputted by the touch panel has been switched to the cursor control function and the processing unit detects a click operation performed on the touch panel, the processing unit switches the coordinate information outputted by the touch panel from the cursor control function to the virtual numeric keypad function.

According to the claimed invention, the touch panel comprises a plurality of numeric areas, when the processing unit detects that the click operation performs at least three clicks on the numeric areas, the processing unit switches the coordinate information outputted by the touch panel from the cursor control function to the virtual numeric keypad function.

According to the claimed invention, the touch panel comprises a function switching area, when the processing unit detects that the click operation performs at least one click on the function switching area, the processing unit switches the coordinate information outputted by the touch panel from the cursor control function to the virtual numeric keypad function.

According to the claimed invention, when the coordinate information outputted by the touch panel has been switched to the virtual numeric keypad function and the processing unit detects a slide operation performed on the touch panel, the processing unit switches the coordinate information outputted by the touch panel from the virtual numeric keypad function to the cursor control function.

According to the claimed invention, when the processing unit detects that a trajectory length performed by the slide operation on the touch panel is larger than a threshold, the processing unit switches the coordinate information outputted by the touch panel from the virtual numeric keypad function to the cursor control function.

According to the claimed invention, when the processing unit detects that a trajectory performed by the slide operation on the touch panel matches a user-defined trajectory, the processing unit switches the coordinate information outputted by the touch panel from the virtual numeric keypad function to the cursor control function.

According to the claimed invention, the keyswitches further comprises a function switching key for triggering the processing unit to switch the coordinate information outputted by the touch panel to the cursor control function or the virtual numeric keypad function.

According to the claimed invention, a plurality of separated lines is printed on the touch panel and used for separating the touch panel into a plurality of numeric areas.

According to the claimed invention, the input device further comprises a light emitting unit disposed on the housing and electrically connected to the processing unit, wherein the light emitting unit is used for emitting light to indicate that the coordinate information outputted by the touch panel has been switched to the cursor control function or the virtual numeric keypad function.

According to the claimed invention, a function switching method for switching coordinate information outputted by a touch panel to a cursor control function or a virtual numeric keypad function comprises steps of detecting whether a click operation or a slide operation is performed on the touch panel; when the coordinate information outputted by the touch panel has been switched to the cursor control function and the click operation performed on the touch panel is detected, switching the coordinate information outputted by the touch panel from the cursor control function to the virtual numeric keypad function; and when the coordinate information outputted by the touch panel has been switched to the virtual numeric keypad function and the slide operation performed on the touch panel is detected, switching the coordinate information outputted by the touch panel from the virtual numeric keypad function to the cursor control function.

According to the claimed invention, the touch panel comprises a plurality of numeric areas, the function switching method further comprises step of when detecting that the click operation performs at least three clicks on the numeric areas, switching the coordinate information outputted by the touch panel from the cursor control function to the virtual numeric keypad function.

According to the claimed invention, the touch panel comprises a function switching area, the function switching method further comprises step of when detecting that the click operation performs at least one click on the function switching area, switching the coordinate information outputted by the touch panel from the cursor control function to the virtual numeric keypad function.

According to the claimed invention, the function switching method further comprises step of when detecting that a trajectory length performed by the slide operation on the touch panel is larger than a threshold, switching the coordinate information outputted by the touch panel from the virtual numeric keypad function to the cursor control function.

According to the claimed invention, the function switching method further comprises step of when detecting that a trajectory performed by the slide operation on the touch panel matches a user-defined trajectory, switching the coordinate information outputted by the touch panel from the virtual numeric keypad function to the cursor control function.

According to the claimed invention, the function switching method further comprises step of controlling a light emitting unit to emit light to indicate that the coordinate information outputted by the touch panel has been switched to the cursor control function or the virtual numeric keypad function.

As mentioned in the above, the input device of the invention allows a user to switch the coordinate information outputted by the touch panel to the cursor control function or the virtual numeric keypad function. For example, when the user needs input a large number of numerals and the coordinate information outputted by the touch panel has been switched to the cursor control function, the user can perform the click operation on the touch panel or press the function switching key, so as to switch the coordinate information outputted by the touch panel form the cursor control function to the virtual numeric keypad function. Accordingly, the user can operate the touch panel to perform the virtual numeric keypad function, so as to input a large number of numerals easily. On the other hand, when the user needs to operate the touch panel to perform the cursor control function and the coordinate information outputted by the touch panel has been switched to the virtual numeric keypad function, the user can perform the slide operation on the touch panel or press the function switching key, so as to switch the coordinate information outputted by the touch panel form the virtual numeric keypad function to the cursor control function. Since the touch panel of the input device of the invention can be used to perform the cursor control function and the virtual numeric keypad function, it is convenient in use and the product competitiveness can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a notebook computer of the prior art.

FIG. 2 is a schematic diagram illustrating an input device applied to a notebook computer according to an embodiment of the invention.

FIG. 3 is a schematic diagram illustrating an input device connected to a flat computer according to an embodiment of the invention.

FIG. 4 is a functional block diagram illustrating the input device shown in FIGS. 2 and 3.

FIG. 5 is a schematic diagram illustrating the input device shown in FIGS. 2 and 3.

FIG. 6 is a flowchart illustrating a function switching method according to an embodiment of the invention.

FIG. 7 is a schematic diagram illustrating a click operation performed to switch the coordinate information outputted by the touch panel from the cursor control function to the virtual numeric keypad function.

FIG. 8 is a schematic diagram illustrating another click operation performed to switch the coordinate information outputted by the touch panel from the cursor control function to the virtual numeric keypad function.

FIG. 9 is a schematic diagram illustrating a slide operation performed to switch the coordinate information outputted by the touch panel from the virtual numeric keypad function to the cursor control function.

FIG. 10 is a schematic diagram illustrating another slide operation performed to switch the coordinate information outputted by the touch panel from the virtual numeric keypad function to the cursor control function.

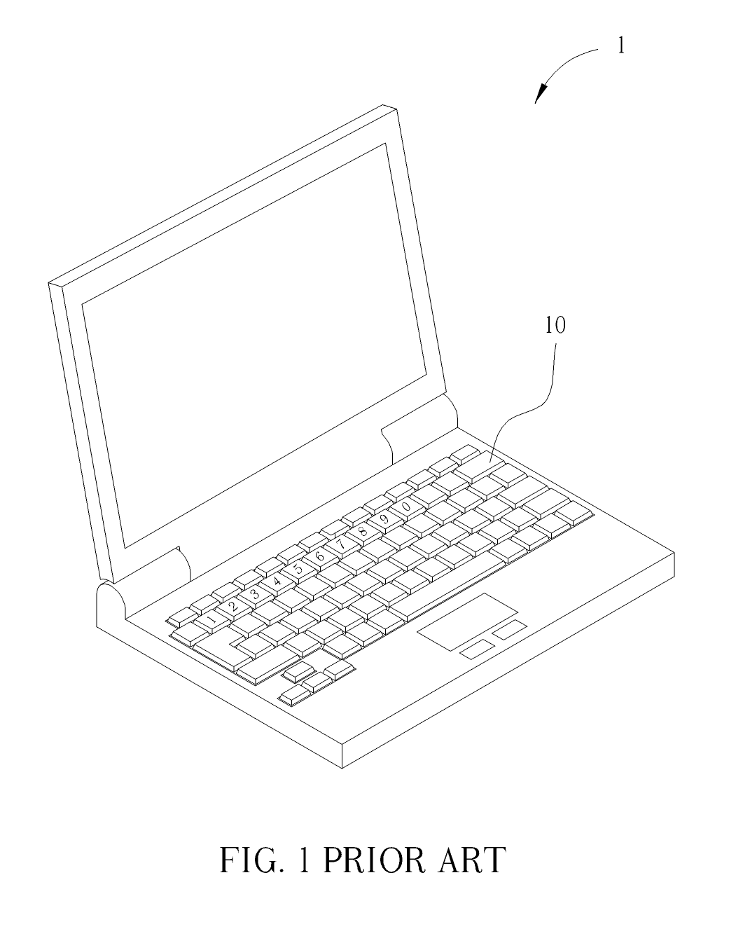

### DETAILED DESCRIPTION

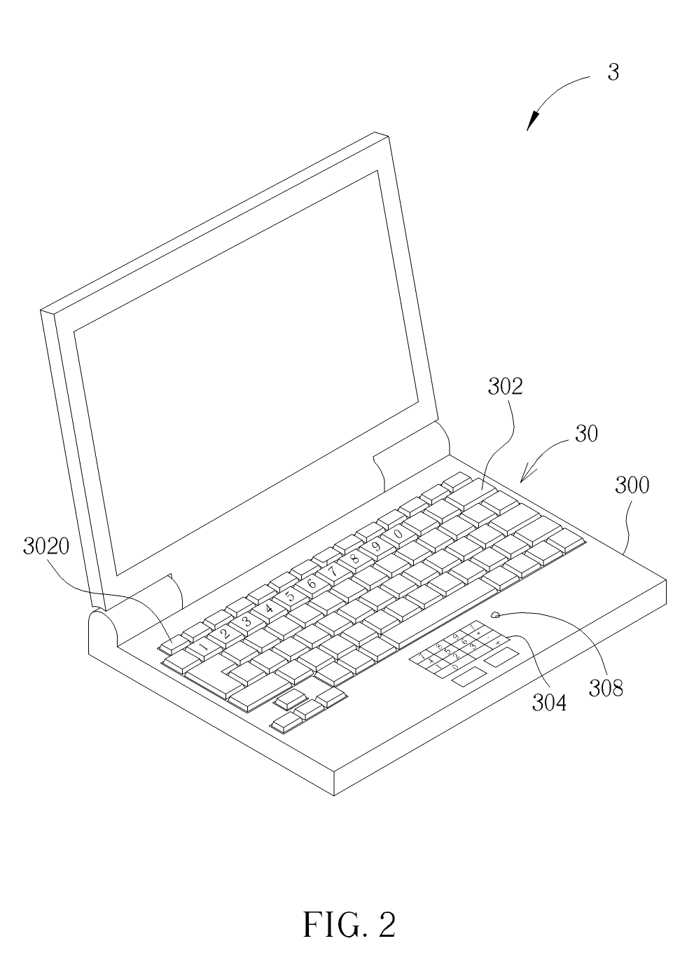

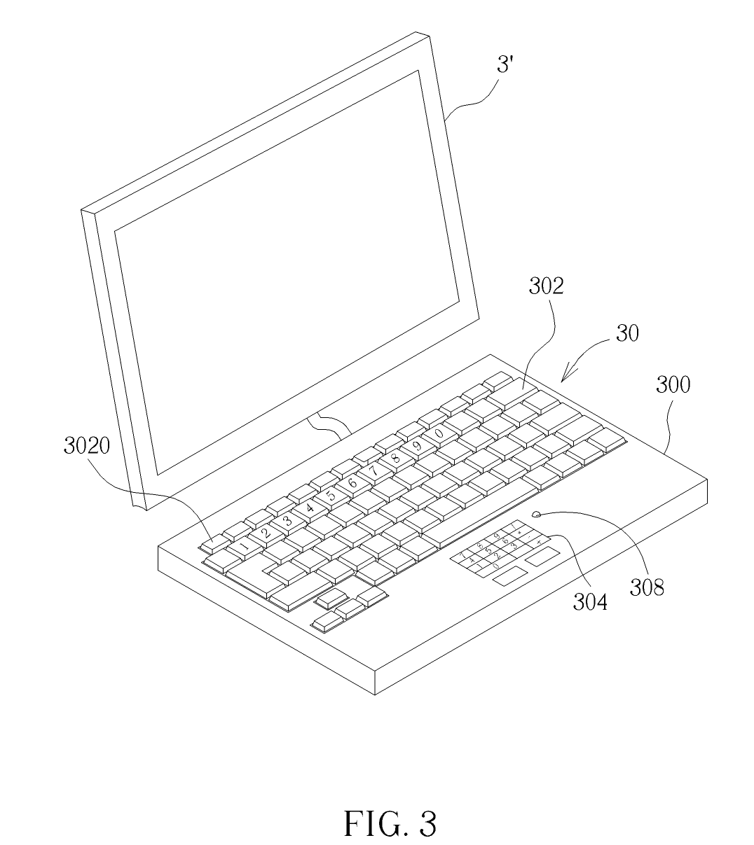

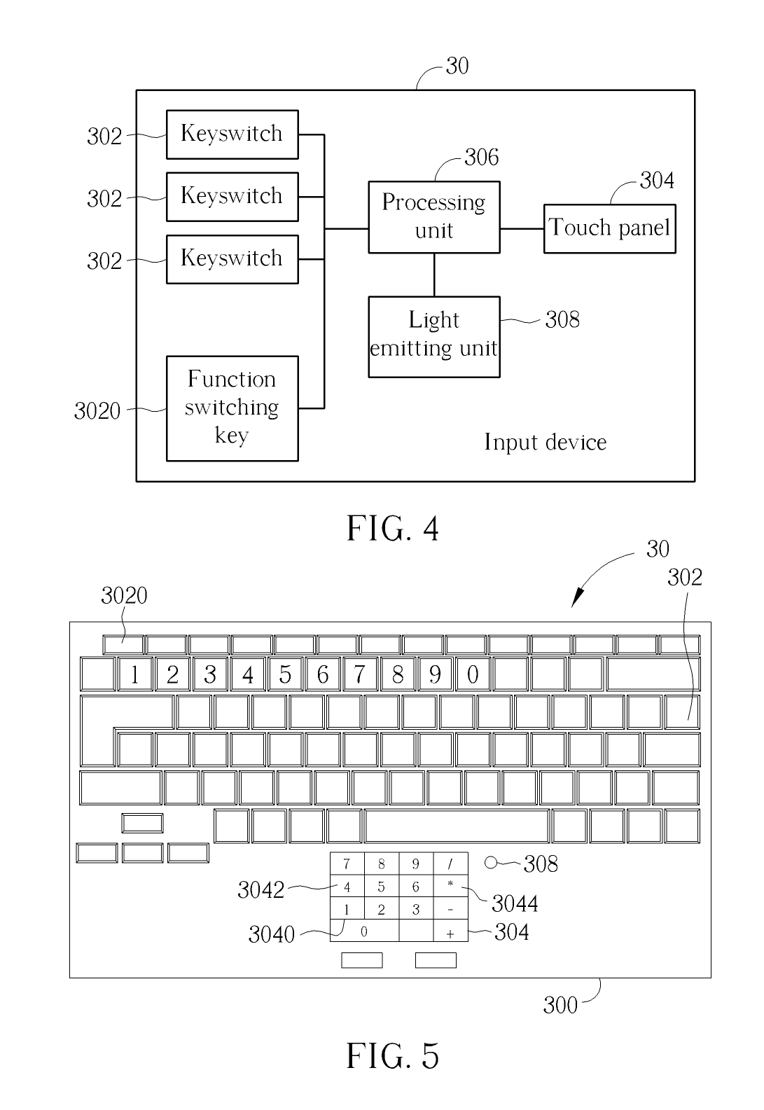

Referring to FIGS. 2 to 5, FIG. 2 is a schematic diagram illustrating an input device 30 applied to a notebook computer 3 according to an embodiment of the invention, FIG. 3 is a schematic diagram illustrating an input device 30 connected to a flat computer 3′ externally according to an embodiment of the invention, FIG. 4 is a functional block diagram illustrating the input device 30 shown in FIGS. 2 and 3, and FIG. 5 is a schematic diagram illustrating the input device 30 shown in FIGS. 2 and 3. As shown in FIGS. 2 and 3, the input device 30 of the invention may be applied to a notebook computer 3 or connected to a flat computer 3′ externally according to practical applications. Furthermore, the flat computer 3′ maybe replaced by a mobile phone, a personal digital assistant, a personal computer or other electronic devices capable of being connected with the input device 30 according to practical applications.

As shown in FIGS. 2 to 4, the input device 30 comprises a housing 300, a plurality of keyswitches 302, a touch panel 304, a processing unit 306 and a light emitting unit 308. The keyswitches 302, the touch panel 304 and the light emitting unit 308 are disposed on the housing 300. The processing unit 306 is disposed in the housing 300 and electrically connected to the keyswitches 302, the touch panel 304 and the light emitting unit 308. In this embodiment, the keyswitches 302 may be substantial keys capable of providing a stroke feeling for a user while he/she presses one of them; the touch panel 304 may be a resistance-type touch panel, a capacitance-type touch panel or other touch panels; the processing unit 306 may be a processor or controller with data calculating/processing function; and the light emitting unit 308 may be a light emitting diode or other light emitting devices. When the input device 30 is applied to the notebook computer 3, the housing 300 may be further equipped with some necessary hardware or software components for specific purposes, such as a power supply, a hard disc, an operating system, a communication module, etc., and it depends on practical applications.

In this embodiment, the processing unit 306 is used for switching coordinate information outputted by the touch panel 304 to a cursor control function or a virtual numeric keypad function. In other words, the input device 30 of the invention allows a user to switch the coordinate information outputted by the touch panel 304 to the cursor control function or the virtual numeric keypad function. Furthermore, as shown in FIG. 5, a plurality of separated lines 3040 is printed on the touch panel 304 and used for separating the touch panel 304 into a plurality of numeric areas 3042 and a plurality of symbolic areas 3044 for the user to recognize the numerals and symbols on the touch panel 304. It is reasonably expected that the invention may print the numerals and symbols in the numeric areas 3042 and the symbolic areas 3044 correspondingly, or may dispose light emitting units (e.g. light emitting diodes) below the numeric areas 3042 and the symbolic areas 3044 correspondingly, so as to show the numerals and symbols by the light emitted by the light emitting units. It should be noted that the invention may also separate the touch panel 304 into a plurality of numeric areas 3042 only according to practical applications.

When the coordinate information outputted by the touch panel 304 has been switched to the cursor control function, the user can perform a slide operation on the touch panel 304, so as to trigger the processing unit 306 to control a cursor to move or execute a left/right mouse button function according to the coordinate information outputted by the touch panel 304. On the other hand, when the coordinate information outputted by the touch panel 304 has been switched to the virtual numeric keypad function, the user can perform a click operation on the tough panel 304, so as to trigger the processing unit 306 to output a numeral or a symbol according to the coordinate information outputted by the touch panel 304. In this embodiment, a look-up table may be built in a memory or a storage device (not shown) of the input device 30, wherein the look-up table is used for recording a plurality of numerals and symbols corresponding to the numeric areas 3042 and the symbolic areas 3044, respectively, so that the processing unit 306 can look the desired numerals and symbols up in the look-up table and output the desired numerals and symbols for the user.

In this embodiment, the keyswitches 302 may comprise a function switching key 3020 for triggering the processing unit 306 to switch the coordinate information outputted by the touch panel 304 to the cursor control function or the virtual numeric keypad function. In other words, the user can press the function switching key 3020 to trigger the processing unit 306 to switch the coordinate information outputted by the touch panel 304 to the cursor control function or the virtual numeric keypad function. For example, when the coordinate information outputted by the touch panel 304 has been switched to the cursor control function, the user can press the function switching key 3020 to trigger the processing unit 306 to switch the coordinate information outputted by the touch panel 304 from the cursor control function to the virtual numeric keypad function. Similarly, when the coordinate information outputted by the touch panel 304 has been switched to the virtual numeric keypad function, the user can press the function switching key 3020 to trigger the processing unit 306 to switch the coordinate information outputted by the touch panel 304 from the virtual numeric keypad function to the cursor control function.

In this embodiment, the light emitting unit 308 is used for emitting light to indicate that the coordinate information outputted by the touch panel 304 has been switched to the cursor control function or the virtual numeric keypad function. For example, when the coordinate information outputted by the touch panel 304 has been switched to the cursor control function, the processing unit 306 may control the light emitting unit 308 to emit light to indicate that the coordinate information outputted by the touch panel 304 has been switched to the cursor control function; and when the coordinate information outputted by the touch panel 304 has been switched to the virtual numeric keypad function, the processing unit 306 may control the light emitting unit 308 not to emit light to indicate that the coordinate information outputted by the touch panel 304 has been switched to the virtual numeric keypad function. It is reasonably expected that the processing unit 306 may also control the light emitting unit 308 to emit light with different colors to indicate that the coordinate information outputted by the touch panel 304 has been switched to the cursor control function or the virtual numeric keypad function. For example, the processing unit 306 may control the light emitting unit 308 to emit red light to indicate that the coordinate information outputted by the touch panel 304 has been switched to the cursor control function, and the processing unit 306 may control the light emitting unit 308 to emit green light to indicate that the coordinate information outputted by the touch panel 304 has been switched to the virtual numeric keypad function. It should be noted that the invention may also show a specific pattern or light on a screen of the notebook computer 3 or the flat computer 3′ through software, so as to indicate that the coordinate information outputted by the touch panel 304 has been switched to the cursor control function or the virtual numeric keypad function. Accordingly, the user can easily recognize that the coordinate information outputted by the touch panel 304 has been switched to the cursor control function or the virtual numeric keypad function through the light emitted by the light emitting unit 308 or the specific pattern or light shown on the screen.

In addition, since the user mainly perform a slide operation on the touch panel 304 to execute the cursor control function, the invention may allow the user to perform a click operation on the touch panel 304 to trigger the processing unit 306 to switch the coordinate information outputted by the touch panel 304 from the cursor control function to the virtual numeric keypad function. Still further, since the user mainly perform a click operation on the touch panel 304 to execute the virtual numeric keypad function, the invention may allow the user to perform a slide operation on the touch panel 304 to trigger the processing unit 306 to switch the coordinate information outputted by the touch panel 304 from the virtual numeric keypad function to the cursor control function.

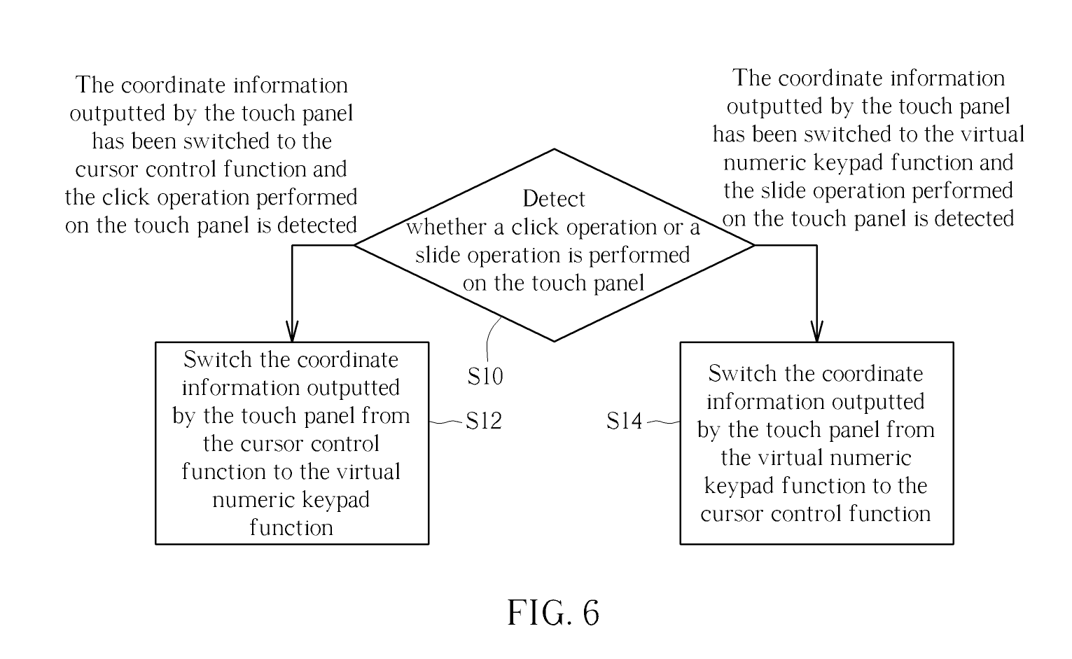

Referring to FIG. 6, FIG. 6 is a flowchart illustrating a function switching method according to an embodiment of the invention. The function switching method shown in FIG. 6 can be implemented by the input device 30 shown in FIGS. 2 to 5. First of all, the processing unit 306 detects whether a click operation or a slide operation is performed on the touch panel 304 (step S10 in FIG. 6). When the coordinate information outputted by the touch panel 304 has been switched to the cursor control function and the click operation performed on the touch panel 304 is detected by the processing unit 306, the processing unit 306 switches the coordinate information outputted by the touch panel 304 from the cursor control function to the virtual numeric keypad function (step S12 in FIG. 6). On the other hand, when the coordinate information outputted by the touch panel 304 has been switched to the virtual numeric keypad function and the slide operation performed on the touch panel 304 is detected by the processing unit 306, the processing unit 306 switches the coordinate information outputted by the touch panel 304 from the virtual numeric keypad function to the cursor control function (step S14 in FIG. 6).

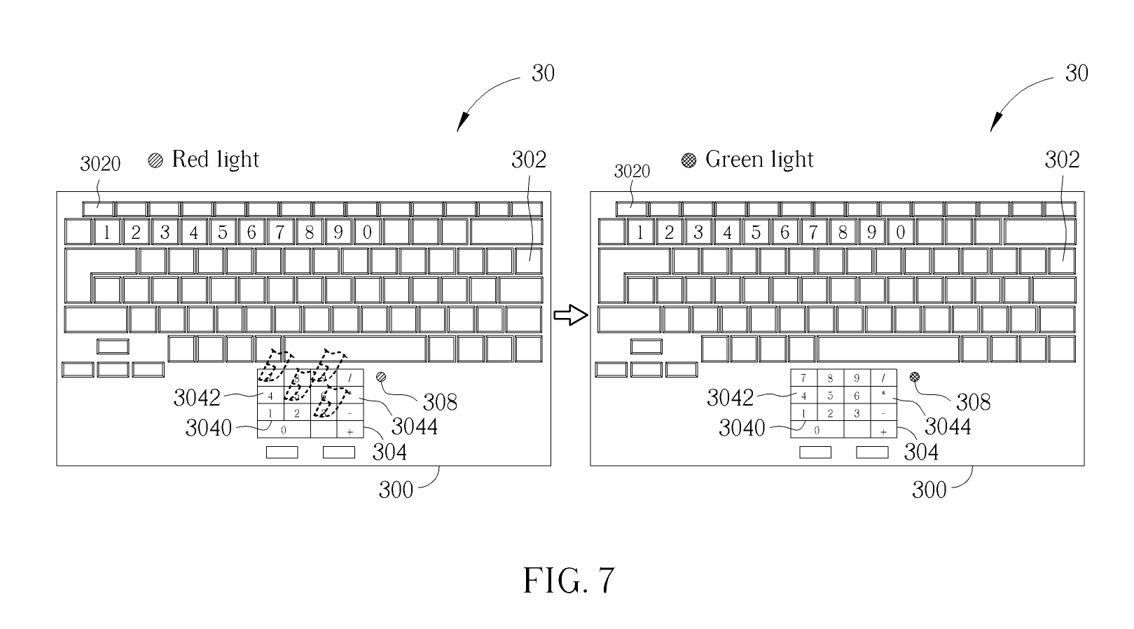

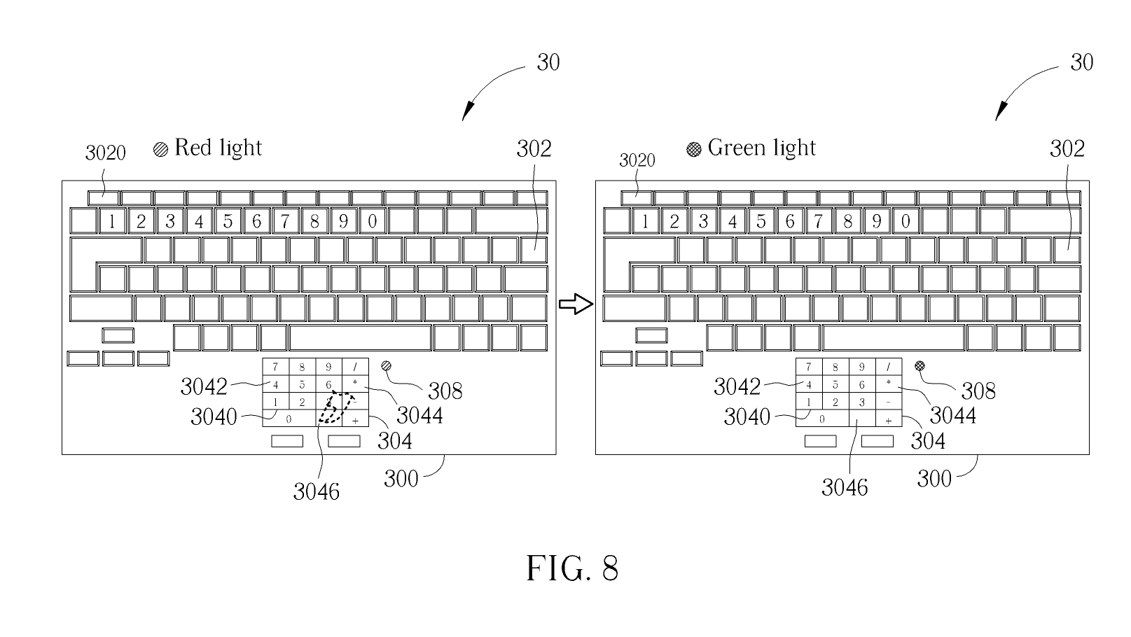

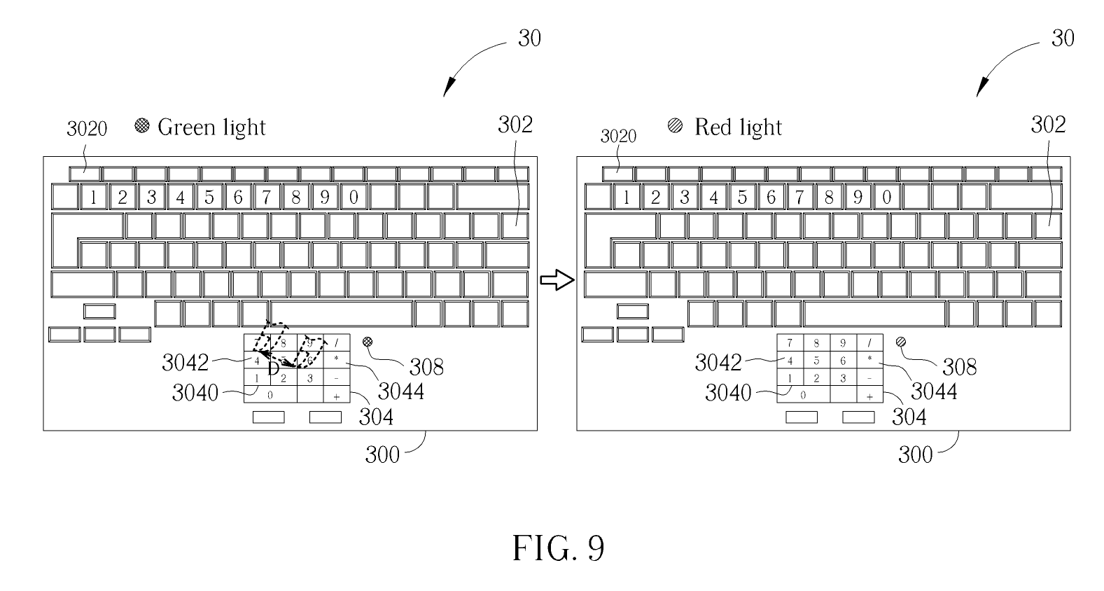

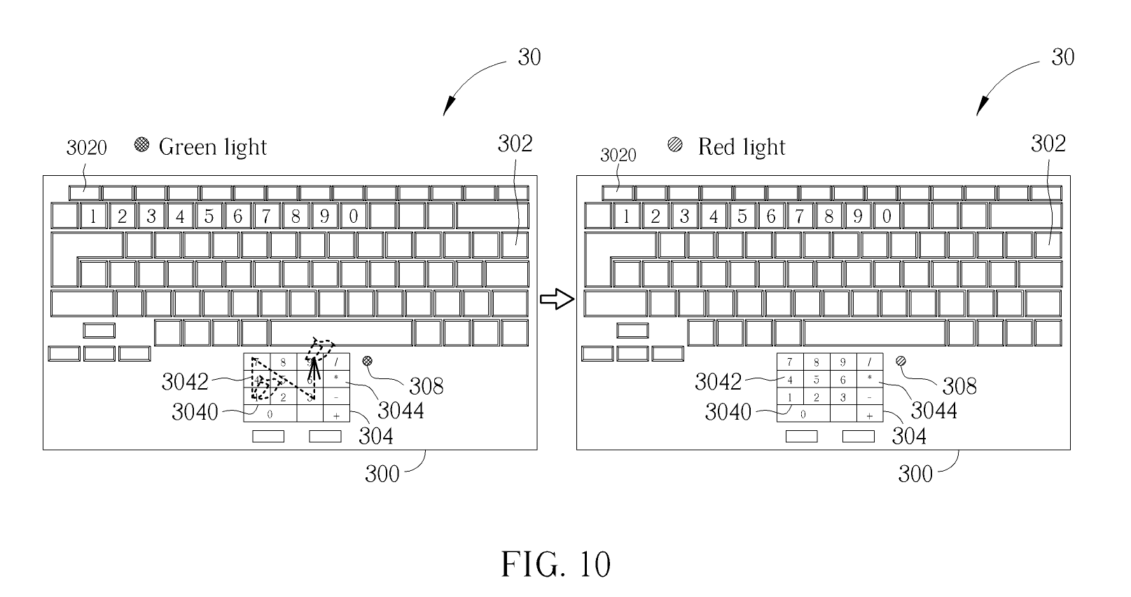

Referring to FIGS. 7 to 10, FIG. 7 is a schematic diagram illustrating a click operation performed to switch the coordinate information outputted by the touch panel 304 from the cursor control function to the virtual numeric keypad function, FIG. 8 is a schematic diagram illustrating another click operation performed to switch the coordinate information outputted by the touch panel 304 from the cursor control function to the virtual numeric keypad function, FIG. 9 is a schematic diagram illustrating a slide operation performed to switch the coordinate information outputted by the touch panel 304 from the virtual numeric keypad function to the cursor control function, and FIG. 10 is a schematic diagram illustrating another slide operation performed to switch the coordinate information outputted by the touch panel 304 from the virtual numeric keypad function to the cursor control function.

As mentioned in the above, the touch panel 304 comprises a plurality of numeric areas 3042. Therefore, the invention may allow the user to set a numeric password consisting of at least three numerals beforehand, wherein the processing unit 306 switches the coordinate information outputted by the touch panel 304 from the cursor control function to the virtual numeric keypad function according to the password. Afterward, when the processing unit 306 detects that the click operation from the user performs at least three clicks on the numeric areas 3042, the processing unit 306 switches the coordinate information outputted by the touch panel 304 from the cursor control function to the virtual numeric keypad function. As shown in FIG. 7, when the coordinate information outputted by the touch panel 304 has been switched to the cursor control function (e.g. indicated by red light emitted by the light emitting unit 308), the user can input the preset numeric password (e.g. 7, 5, 3 and 9 in order) by touching the numeric areas 3042 of the touch panel 304, so as to switch the coordinate information outputted by the touch panel 304 from the cursor control function to the virtual numeric keypad function (e.g. indicated by green light emitted by the light emitting unit 308). It should be noted that since the numeric password consists of at least three numerals, it can be distinguished from one-click or double-click function clearly.

In addition to the aforesaid switching manner, the touch panel 304 may comprise a function switching area 3046, as shown in FIG. 8. When the processing unit 306 detects that the click operation from the user performs at least one click on the function switching area 3046, the processing unit 306 switches the coordinate information outputted by the touch panel 304 from the cursor control function to the virtual numeric keypad function. As shown in FIG. 8, when the coordinate information outputted by the touch panel 304 has been switched to the cursor control function (e.g. indicated by red light emitted by the light emitting unit 308), the user can touch the function switching area 3046 of the touch panel 304 once, so as to switch the coordinate information outputted by the touch panel 304 from the cursor control function to the virtual numeric keypad function (e.g. indicated by green light emitted by the light emitting unit 308).

On the other hand, when the processing unit 306 detects that a trajectory length performed by the slide operation form the user on the touch panel 304 is larger than a threshold, the processing unit 306 switches the coordinate information outputted by the touch panel 304 from the virtual numeric keypad function to the cursor control function. As shown in FIG. 9, when the coordinate information outputted by the touch panel 304 has been switched to the virtual numeric keypad function (e.g. indicated by green light emitted by the light emitting unit 308), the user can perform the slide operation on the touch panel 304, so as to generate a trajectory length D. When the processing unit 306 detects that the trajectory length D is larger than the threshold (e.g. 3 cm), the processing unit 306 switches the coordinate information outputted by the touch panel 304 from the virtual numeric keypad function to the cursor control function (e.g. indicated by red light emitted by the light emitting unit 308).

In addition to the aforesaid switching manner, the invention may allow the user to define a trajectory beforehand, wherein the processing unit 306 switches the coordinate information outputted by the touch panel 304 from the virtual numeric keypad function to the cursor control function according to the user-defined trajectory. When the processing unit 306 detects that a trajectory performed by the slide operation form the user on the touch panel 304 matches the user-defined trajectory, the processing unit 306 switches the coordinate information outputted by the touch panel 304 from the virtual numeric keypad function to the cursor control function. As shown in FIG. 10, when the coordinate information outputted by the touch panel 304 has been switched to the virtual numeric keypad function (e.g. indicated by green light emitted by the light emitting unit 308), the user can perform the slide operation on the touch panel 304, so as to generate a specific trajectory (e.g. N-shaped). When the processing unit 306 detects that the specific trajectory matches the user-defined trajectory (e.g. N-shaped), the processing unit 306 switches the coordinate information outputted by the touch panel 304 from the virtual numeric keypad function to the cursor control function (e.g. indicated by red light emitted by the light emitting unit 308).

It should be noted that the control logics of the aforesaid function switching method can be implemented by software. The software can be executed in any input devices with the touch panel. It is reasonably expected that each part or function of the control logics may be implemented by software, hardware or the combination thereof.

As mentioned in the above, the input device of the invention allows a user to switch the coordinate information outputted by the touch panel to the cursor control function or the virtual numeric keypad function. For example, when the user needs input a large number of numerals and the coordinate information outputted by the touch panel has been switched to the cursor control function, the user can perform the click operation on the touch panel or press the function switching key, so as to switch the coordinate information outputted by the touch panel form the cursor control function to the virtual numeric keypad function. Accordingly, the user can operate the touch panel to perform the virtual numeric keypad function, so as to input a large number of numerals easily. On the other hand, when the user needs to operate the touch panel to perform the cursor control function and the coordinate information outputted by the touch panel has been switched to the virtual numeric keypad function, the user can perform the slide operation on the touch panel or press the function switching key, so as to switch the coordinate information outputted by the touch panel form the virtual numeric keypad function to the cursor control function. Since the touch panel of the input device of the invention can be used to perform the cursor control function and the virtual numeric keypad function, it is convenient in use and the product competitiveness can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An input device comprising:
a housing;
a plurality of keyswitches disposed on the housing;
a touch panel disposed on the housing; and
a processing unit disposed in the housing and electrically connected to the keyswitches and the touch panel, the processing unit being used for switching coordinate information outputted by the touch panel to a cursor control function or a virtual numeric keypad function.

2. The input device of claim 1, wherein when the coordinate information outputted by the touch panel has been switched to the cursor control function and the processing unit detects a click operation performed on the touch panel, the processing unit switches the coordinate information outputted by the touch panel from the cursor control function to the virtual numeric keypad function.

3. The input device of claim 2, wherein the touch panel comprises a plurality of numeric areas, when the processing unit detects that the click operation performs at least three clicks on the numeric areas, the processing unit switches the coordinate information outputted by the touch panel from the cursor control function to the virtual numeric keypad function.

4. The input device of claim 2, wherein the touch panel comprises a function switching area, when the processing unit detects that the click operation performs at least one click on the function switching area, the processing unit switches the coordinate information outputted by the touch panel from the cursor control function to the virtual numeric keypad function.

5. The input device of claim 1, wherein when the coordinate information outputted by the touch panel has been switched to the virtual numeric keypad function and the processing unit detects a slide operation performed on the touch panel, the processing unit switches the coordinate information outputted by the touch panel from the virtual numeric keypad function to the cursor control function.

6. The input device of claim 5, wherein when the processing unit detects that a trajectory length performed by the slide operation on the touch panel is larger than a threshold, the processing unit switches the coordinate information outputted by the touch panel from the virtual numeric keypad function to the cursor control function.

7. The input device of claim 5, wherein when the processing unit detects that a trajectory performed by the slide operation on the touch panel matches a user-defined trajectory, the processing unit switches the coordinate information outputted by the touch panel from the virtual numeric keypad function to the cursor control function.

8. The input device of claim 1, wherein the keyswitches further comprises a function switching key for triggering the processing unit to switch the coordinate information outputted by the touch panel to the cursor control function or the virtual numeric keypad function.

9. The input device of claim 1, wherein a plurality of separated lines is printed on the touch panel and used for separating the touch panel into a plurality of numeric areas.

10. The input device of claim 1, further comprising a light emitting unit disposed on the housing and electrically connected to the processing unit, wherein the light emitting unit is used for emitting light to indicate that the coordinate information outputted by the touch panel has been switched to the cursor control function or the virtual numeric keypad function.

11. A function switching method for switching coordinate information outputted by a touch panel to a cursor control function or a virtual numeric keypad function, the function switching method comprising:
detecting whether a click operation or a slide operation is performed on the touch panel ;
when the coordinate information outputted by the touch panel has been switched to the cursor control function and the click operation performed on the touch panel is detected, switching the coordinate information outputted by the touch panel from the cursor control function to the virtual numeric keypad function; and
when the coordinate information outputted by the touch panel has been switched to the virtual numeric keypad function and the slide operation performed on the touch panel is detected, switching the coordinate information outputted by the touch panel from the virtual numeric keypad function to the cursor control function.

12. The function switching method of claim 11, wherein the touch panel comprises a plurality of numeric areas, the function switching method further comprises:
when detecting that the click operation performs at least three clicks on the numeric areas, switching the coordinate information outputted by the touch panel from the cursor control function to the virtual numeric keypad function.

13. The function switching method of claim 11, wherein the touch panel comprises a function switching area, the function switching method further comprises:
when detecting that the click operation performs at least one click on the function switching area, switching the coordinate information outputted by the touch panel from the cursor control function to the virtual numeric keypad function.

14. The function switching method of claim 11, further comprising:
when detecting that a trajectory length performed by the slide operation on the touch panel is larger than a threshold, switching the coordinate information outputted by the touch panel from the virtual numeric keypad function to the cursor control function.

15. The function switching method of claim 11, further comprising:
when detecting that a trajectory performed by the slide operation on the touch panel matches a user-defined trajectory, switching the coordinate information outputted by the touch panel from the virtual numeric keypad function to the cursor control function.

16. The function switching method of claim 11, further comprising:
controlling a light emitting unit to emit light to indicate that the coordinate information outputted by the touch panel has been switched to the cursor control function or the virtual numeric keypad function.
